(19) United States
(12) Patent Application Publication
(10) Pub. No.: US 2015/0081361 A1
(43) Pub. Date: Mar. 19, 2015

(54) COLLABORATIVE PERSONAL ASSISTANT SYSTEM FOR DELEGATING PROVISION OF SERVICES BY THIRD PARTY TASK PROVIDERS AND METHOD THEREFOR

(71) Applicant: Samsung Electronics Co., Ltd., Gyeonggi-do (KR)

(72) Inventors: Ji-Cheol Lee, Gyeonggi-do (KR); Sung-Ho Choi, Gyeonggi-do (KR)

(21) Appl. No.: 14/385,769

(22) PCT Filed: Mar. 14, 2013
(86) PCT No.: PCT/KR2013/002054

§ 371 Date: Sep. 16, 2014

(30) Foreign Application Priority Data
Mar. 16, 2012 (KR) 10-2012-0027137

(51) Int. Cl. G06Q 10/06; G06F 17/30

(52) U.S. Cl. CPC G06Q 10/06311; G06F 17/30401
USPC 705/7.13

(57) ABSTRACT

Provided is a collaborative Personal Assistant (PA) system for delegating provision of services by third party task providers. The system includes a contextual reasoned for searching for a first third party task provider supporting a first task required by a user input by using natural language input patterns for tasks supported by services operated by the third party task providers; and a server comprised of a task delegate unit for providing to the user a service and an action required by the user input for the first task, and providing additional service and actions supporting the first task to the user regardless of the user input.

### TECHNICAL FIELD

The present invention relates to a collaborative personal assistant system for delegating provision of services by third party task providers and a method therefor

### BACKGROUND ART

In general, a virtual Personal Assistant (PA) system may perform the tasks required by users by understanding the users' intentions, and by learning and applying user profile and context information. The virtual PA system may perform actions corresponding to the tasks by using natural language processing for responding to a user's query, making recommendations, and delegating requests in an expanded set of web services.

FIG. 1 illustrates architecture of a general virtual PA system.

Referring to FIG. 1, the virtual PA system 100 includes a PA server 102, a network 104, a user device 106 and a third party task server 108. Although not illustrated in the drawing, the PA server 102 includes three technical components. The technical components include a conversational interface, a personal context awareness unit, and a service delegate unit. The conversational interface is a dialog-style natural language user interface that acquires, from the user, natural language inputs of queries in the form of either the human speech or the text typed by the user. The PA server 102 is aware of personal contexts in advance. The personal contexts may include, for example, information about the place where the user is presently located, resides, or works. The PA server 102 delegates provision of services supported by the third party task server 108, for the user. Although the virtual PA system 100 is assumed to have only one third party task server 108 by way of example, the PA server 102 may delegate provision of services supported by a plurality of third party task servers. Provision of services supported by the third party task server 108 may correspond to, for example, operations such as finding small businesses/restaurants, regional events and movie theaters, reserving restaurants, or actually answering to queries.

The general virtual PA system 100 is comprised of a PA application that operates in the PA server 102, the user device 106 and the third party task server 108. The user device 106 may be a Personal Digital Assistant (PDA) and an intelligent terminal (for example, a smart phone and a tablet Personal Computer (PC)) made by adding computer support functions such as Internet communication and information search, to a mobile phone.

FIG. 2 is a signal flow diagram illustrating an operation of a general virtual PA system.

Referring to FIG. 2, the virtual PA system includes a user device 200, a PA server 202 and an external third party task server 204.

In step 206, the user device 200 receives a user input from a user. The user input may be received in the form of a human-speech (dictated) query or a textual query. An Operation System (OS) or a PA application of the user device 200 may pre-process the dictated human speech from the text by applying the speech-to-text technology.

In step 208, the PA application operating in the user device 200 acquires a user request from the user input, and sends the user request to the PA server 202. The user request may include a user query and additional context information (for example, the location of the device, and the like) such as, for example, the location of the user device 200. The user query may include either a textual query or a dictated query.

For example, Table 1 below is table showing the user request in the form of a message.

TABLE 1
Message: user request

| Name | Description |
|---|---|
| User query | either textual query or dictated query |
| Context | Location of user device and other situational |
| information | context information |

Upon receiving the user request from the PA application in step 210, the PA server 202 performs contextual reasoning (or inference) on the user request in step 212. Specifically, the PA server 202 identifies a user identifier from information about a session to the user device 200. If the user request is in the form of a dictated query (human speech), the PA server 202 performs speech-to-text that expresses the dictated query in a text. The PA server 202 analyzes the user request which is received together with personal context information for identifying the domain where tasks required by the user request are provided. The PA server 202 uses artificial intelligence technologies, such as ‘ontology’, ‘inference’ and ‘pattern matching supporting unified modeling, dictionaries, and dialog models.

In step 214, the PA server 202 sends an interim response to the user device 200 in response to the PA application. The interim response is displayed in the form of a text message for the user, or is delivered to the user in words. An example of this interim response may include “I'm finding a Korean BBQ restaurant for your dinner party today”. In step 216, the user device 200 displays the received interim response in the form of a message shown in Table 2 below.

TABLE 2
Message: interim response

| Name | Description |
|---|---|
| Interim | Text message to be displayed on user device. For |
| response | example, “I'm at near your workplace. I'm finding |
| | Korean BBQ restaurant for your dinner party at |
| | Youngtong today.” |

Thereafter, in order to perform the task that the user request requires from the external third party task server 204, the PA server 202 configures a query for delivering the request, and sends the configured query to the external third party task server 204 in step 218. In response, the external third party task server 204 processes the received query in step 220, and sends a query response including the task corresponding to the query to the PA server 202 in step 222. If there is a plurality of tasks that the external third party task server 204 provides as the query response, the PA server 202 determines the priority to define items to be finally displayed for the user among the tasks, and determines the final response comprised of the items selected based on the determined priority, in step 224. In step 226, the PA server 202 sends the final response to the user device 200. In step 228, the user device 200 displays the final response on its screen.

### DISCLOSURE OF INVENTION

### Technical Problem

The above-described general virtual PA system is inflexible due to its limited number of third party task providers that provide services to users. Even though there is a plurality of actions or services that the third party task provider can provide, it is not possible for the virtual PA system to provide other sets except for the set of actions or services required by the user.

For example, it will be assumed that a user requests a service provided by a third party task server which is a music-related site. The third party task server provides a variety of service sets such as playing music using streaming, music download, or purchase service. However, a user of the virtual PA system may use only the services of the third party task server, which can be provided through the virtual PA system. For example, if the PA application provided by the virtual PA system supports an operation of executing a music play application in a user device, or executing a library for playing music contents, the user of the PA application cannot directly access (i.e., download or play) the contents.

In some cases, among the actions provided by the third party task server, user's temporary context information may be required. An example of the actions may include paid services, tarot cards created based on the user information, and reservation services, and the temporary context information may correspond to the location information or the user profile information (for example, phone numbers). The virtual PA system needs to inconveniently check the user whether he or she can provide the temporary context information to the third party task server, if the temporary context information is required for the user.

### Solution to Problem

An aspect of the present invention is to address at least the above-mentioned problems and/or disadvantages and to provide at least the advantages described below. Accordingly, an aspect of the present invention provides a collaborative PA system for delegating provision of services by third party task providers, and a method therefor.

Another aspect of the present invention provides an interface for delegating provision of services supported by a plurality of third party task servers in a collaborative PA system.

Further another aspect of the present invention provides additional service and actions that can be provided through a third party task server providing a task required by a user input.

Yet another aspect of the present invention provides a collaborative PA system that delivers personal profiles required to perform a task corresponding to a user input from the user to a third party task server upon permission of the user.

In accordance with one aspect of the present invention, there is provided a collaborative Personal Assistant (PA) system for delegating provision of services by third party task providers. The collaborative PA system includes a contextual reasoned for searching for a first third party task provider supporting a first task required by a user input by using natural language input patterns for tasks supported by services operated by the third party task providers; and a server comprised of a task delegate unit for providing to the user a service and an action required by the user input for the first task, and providing additional service and actions supporting the first task to the user regardless of the user input.

In accordance with another aspect of the present invention, there is provided a method for delegating provision of services by third party task providers in a collaborative Personal Assistant (PA) system. The method includes searching for a first third party task provider supporting a first task required by a user input by using natural language input patterns for tasks supported by services operated by the third party task providers; providing to the user a service and an action required by the user input for the first task; and providing additional service and actions supporting the first task to the user regardless of the user input.

### Advantageous Effects of Invention

The collaborative PA system for delegating provision of services by third party task providers may provide a third party task server providing a task required by a user input from the user input by a user, and an interface for registering, in a third party task delegate unit, natural language input patterns for helping the collaborative PA system find query commands matched to the task, thereby making it possible to more systematically recognize the user input by the user and more simply find a third party task server providing a task corresponding to the user input. In addition, the collaborative PA system provides additional service and actions that can be provided through the third party task server providing a task required by the user input, regardless of the user's request, thereby making it possible to overcome the inflexibility due to the limited service provision by the third party task server. Finally, the collaborative PA system acquires use permission about user's personal profile information in advance, and delivers it to the third party task server, thereby preventing the third party task server from performing the procedure of requesting and acquiring the user's personal profile information while providing the task to the user.

### BRIEF DESCRIPTION OF DRAWINGS

The above and other aspects, features and advantages of certain exemplary embodiments of the present invention will be more apparent from the following description taken in conjunction with the accompanying drawings, in which:

FIG. 1 illustrates architecture of a general virtual PA system;

FIG. 2 is a signal flow diagram illustrating an operation of a general virtual PA system;

FIG. 3 illustrates architecture of a collaborative PA system according to an embodiment of the present invention;

FIG. 4a is a signal flow diagram illustrating an operation of a collaborative PA system according to a first embodiment of the present invention;

FIG. 4b illustrates an example of a final response provided to a user according to the first embodiment of the present invention;

FIG. 5a is a signal flow diagram illustrating an operation of a collaborative PA system according to a second embodiment of the present invention

FIG. 5b illustrates an example of a screen of a user device, on which a service delegation operation of a collaborative PA system is displayed, according to the second embodiment of the present invention;

FIG. 6a is a signal flow diagram illustrating an operation of a collaborative PA system according to a third embodiment of the present invention;

FIG. 6b illustrates an example of a screen of a user device, on which a request for sharing user profile information of a user is displayed, according to the third embodiment of the present invention; and

FIG. 7 is a signal flow diagram illustrating a pre-processing procedure for user identification between a PA server and a third party task server according to an embodiment of the present invention.

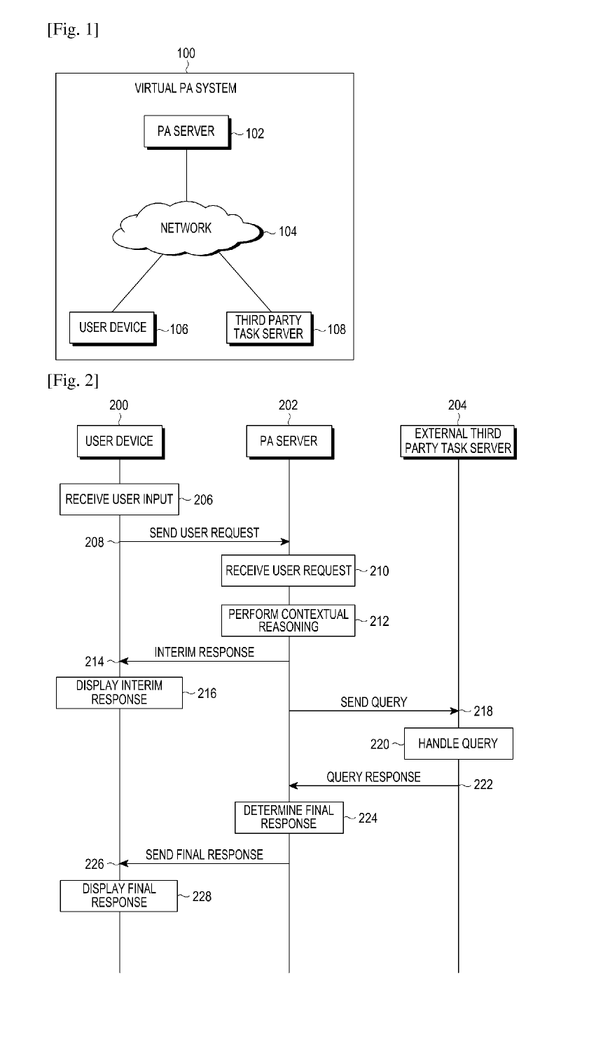

Throughout the drawings, the same drawing reference numerals will be understood to refer to the same elements, features and structures.

### BEST MODE FOR CARRYING OUT THE INVENTION

Preferred embodiments of the present invention will now be described in detail with reference to the accompanying drawings. In the following description, specific details such as detailed configuration and components are merely provided to assist the overall understanding of exemplary embodiments of the present invention. Therefore, it should be apparent to those skilled in the art that various changes and modifications of the embodiments described herein can be made without departing from the scope and spirit of the invention. In addition, descriptions of well-known functions and constructions are omitted for clarity and conciseness.

The present invention provides a collaborative PA system for delegating provision of services by third party task providers, and a method therefor.

A collaborative PA system according to a first embodiment of the present invention provides an interface for delegating provision of services supported by a plurality of third party task servers. The interface is for registering, in a third party task delegate unit, natural language input patterns for helping the collaborative PA system find, from a user input from a user, a third party server providing the task required by the user input and query commands being matched to the task. Accordingly, the collaborative PA system according to the present invention is configured to automatically generate a query for functions of performing a delegation operation of the third party task server through the interface.

A collaborative PA system according to a second embodiment of the present invention provides additional service and actions that can be provided through a third party task server providing a task required by a user input, regardless of the user's need. Specifically, the collaborative PA system delivers an action service endpoint Uniform Resource Locator (URL) where the user may receive an additional service other than the service on the user device through an additional action such as touch or click. Accordingly, the collaborative PA system further includes a contextual reasoned capable of identifying an indicated action from a programming language, such as play and download. The contextual reasoned stores content object metadata including natural language verbal words identifying an action taken for a content object.

A collaborative PA system according to a third embodiment of the present invention provides a third party task delegate unit for registering personal profiles required to perform a task corresponding to a user input from the user. The collaborative PA system acquires user permission for sharing personal profile information such as a location or phone number of the user, during an operation of searching for the results corresponding to the user input from the user. The collaborative PA system transmits the user's personal profile information to the third party task server providing the task, in order to process the task requested by the user.

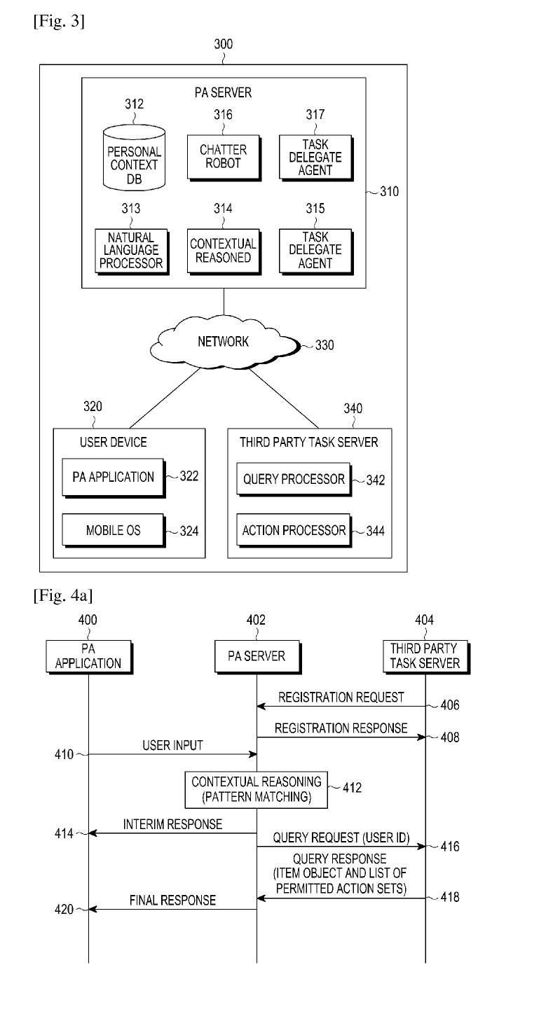

FIG. 3 illustrates architecture of a collaborative PA system according to an embodiment of the present invention.

Referring to FIG. 3, a collaborative PA system 300 includes a PA server 310, a user device 320, a network 330 and third party task server 340.

First, the PA server 310 includes a personal context Database (DB) 312, a chat robot 316, a task delegate DB 317, a Natural Language Processor (NLP) 313, a contextual reasoned 314, and a task delegate agent 315. The user device 320 includes a PA application 322 and a mobile OS 324. The third party task server 340 includes a query processor 342 and an action processor 344. The user device 320 and the third party task server 340 are the same as the general user device and third party task server in terms of operation, so detailed description thereof will be omitted.

The contextual reasoned 314 analyzes the user input which is received together with personal context information of the user, in order to identifier the domain of tasks satisfying the user request. The contextual reasoned 314 performs pre-processing on the dictated user input from the text by applying the speech-to-text technology. The contextual reasoned 314 identifies the domain for providing the task corresponding to the user input. Then, the task delegate agent 315 performs the materialized tasks together with the information extracted from the user input and the user's personal context, which are acquired using the reasoning or dialog. The task delegate DB 317 stores the registration information from, for example, a plurality of third party task servers including the third party task server 340 in FIG. 3. The third party task server 340 represents web service providers providing an application programming interface in order to provide the domain supporting specific services such as a knowledge search engine and a restaurant reservation/search.

For convenience of description, as to operations according to embodiments of the present invention, operations of the detailed components of the PA server will not be described individually. Instead, an operation of the PA server will be described as a whole.

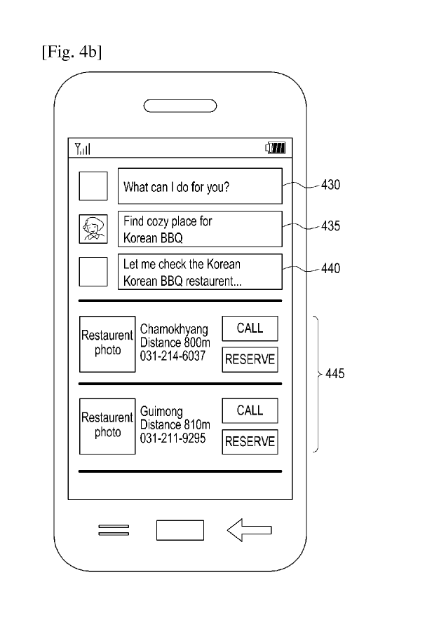

FIG. 4a is a signal flow diagram illustrating an operation of a collaborative PA system according to a first embodiment of the present invention, in which a task corresponding to a user query is provided through pre-registered natural language input patterns. It will be assumed herein that if a user input is requested by a user through a PA application provided by a PA server 402, a third party task server 404 provides a task corresponding to the user input.

Referring to FIG. 4a, in step 406, an operator of the third party task server 404 sends a registration request of a pattern descriptor for a query, which is a user input for its services, to the PA server 402 in order to delegate provision of services supported by the third party task server 404. The pattern descriptor for a query includes a web service query for a delegation operation of a task delegate agent (315 in FIG. 3) included in the PA server 402, and natural language input patterns mapped to the web service query. If any one of the stored natural language input patterns is matched to the user input, the PA server 402 performs a delegation operation of the third party task server 404 supporting a task corresponding to the one input pattern and the web service query mapped to the natural language input pattern. For example, the pattern descriptor for a query may be defined as in Tables 3 and 4 below. The pattern descriptor for a query includes a category of a service for the task, and an end point URL of the third party task server for delegation.

TABLE 3
Pattern descriptor for query

| Name | Description | Example |
|---|---|---|
| Name of task | Verbose name of task provider | “YELP” |
| provider | | |
| Logo of task | URL for task provider logo | |
| provider | | |
| Category | “Restaurant”, “Music Hub”, etc. | |
| List of task | List of task descriptors. See Table 4 | |
| descriptors | for detailed description of task | |
| | descriptors | |
| Description | Human readable description for task | |
| | provider | |

TABLE 4
Task descriptor (pattern to query descriptor)

| Name | Description | Example |
|---|---|---|
| Task general | General description of task including | |
| description | name of task and human readable | |
| | information about task | |
| Input patterns | Natural language patterns which end user | The description may feature grammar |
| description | might say to query information provided | expressed in context-free language. An |
| | by task provider | Example is as follows: |
| | | ### “Does $TEAM win the game?” |
| | | FEATURE GRAMMAR - |
| | | S −> AUX_VP NP[SEM=$TEAM] VP |
| | | AUX_VP −> ‘does’ |
| | | VP −> TV NP[SEM=$GAME] |
| | | ... |
| | | NP[SEM=$TEAM] = Lions \| Eagles |
| | | Example of Input Patterns Description |
| | | SPARQL endpoint URL |
| | | http://example.com/Sparqlep |
| | | Query Syntax |

SELECT team WHERE

| | | |
|---|---|---|
| | | { team won today game } |
| | | Note that alternatively the Query Descriptor |
| | | also may describe the non-SPARQL query |
| | | (WEB 2.0 query, or mobile API) as well |
| Query syntax | Query syntax to retrieve information | An example of query syntax can be |
| description | provided by task provider | SPARQL query. For example, in order to |
| | | query “who won today game?”, the |
| | | SPARQL query can be expressed as follows: |
| | | SELECT team WHERE |
| | | { team won today game } |
| Query result | Description for which kinds of output to | |
| description | be returned by query | |
| End Point | Endpoint URL of task server for query | An example of endpoint URL can be an |
| URL | | SPARQL endpoint URL for example, |
| | | http://example.com/sparqlep |

In step 408, the PA server 402 registers the descriptor for a query, and then sends a registration response to the third party task server 404.

In step 410, the user delivers a user input to the PA server 402 by enabling a PA application 400 in a user device. The user input is delivered in the form of natural language, or in the form of word or text. In step 412, the PA server 402 checks whether the user input requires a delegation service of the third party task server. If the user input requires a delegation service of the third party task server, the PA server 402 performs contextual reasoning on the user input by using the pre-registered pattern descriptor for a query. Specifically, if any one of the stored natural language input patterns is matched to the user input, the PA server 402 identifies a domain of the third party task server supporting the task corresponding to the one input pattern and the web service query mapped to the input pattern. In step 414, the PA server 402 sends an interim response in the form of a message indicating, for example, that it is finding the identified domain, to the user through the PA application 400.

Thereafter, in step 416, a task delegate agent of the PA server 402 configures a query request with personal profile information (including, for example, a query command and parameters for requiring the user identifier) for the user, and sends the query request to the third party task server 404. In response, the third party task server 404 sends a query response to the PA

server 402 in step 418. The query response includes an item object supporting the task required by the user input, and action sets permitted for each item object. For example, the query response may be defined as in Tables 5 to 7.

TABLE 5
Task descriptor

| Name | Description | Example |
|---|---|---|
| Natural | Natural language answer for query | “I found three |
| language | which can be presented to user | restaurants for |
| answer | | your dinner” |
| List of | List of objects that can be answers | |
| objects | for user input question. Detailed | |
| | Description of object is described | |
| | in Table 4. | |
| Next | Possible user action for input | “Would you like |
| step | | to reserve |
| suggestion | | restaurant” |

TABLE 6
Object description

| | | |
|---|---|---|
| Name | Description | Example |

| | |
|---|---|
| Object | Identifier (URI) of object |
| identifier | |
| Displayable | Picture of object, and textual |
| output | description of object. See |
| | example output presented to user. |
| Metadata | Additional metadata to describe |
| ontology | object semantically. It can be |
| | described in RDFa. It can be |
| | used for Personal Assistant to |
| | reason or infer further. |
| List of | List of actions which user can take |
| actions | |

TABLE 7
Action descriptor

| Name | Description | Example |
|---|---|---|
| Action | Identifier (URI) of action | |
| identifier | | |
| Action | Endpoint URL for task server to | |
| endpoint | perform specified action such as | |
| URL | “play”, “download”, “reserve”, | |
| | and “buy”. | |
| Linguistic | Linguistic verb which user can say | ‘play’, |
| keyword | when user wants to perform | ‘download’, |
| | action. | ‘like’, |
| | | ‘reserve’, |
| | | ‘buy’ |
| Query | Query syntax to perform specified | |
| syntax | action provided by task provider | |
| description | for end user | |

In step 420, the PA server 402 sends a final response for the user input through the PA application 400. The final response may be displayed as in, for example, FIG. 4b.

FIG. 4b illustrates an example of a final response provided to a user according to the first embodiment of the present invention.

Referring to FIG. 4b, ‘what can I do for you?’ indicated by reference numeral 430 represents an example of a query that is displayed on a user device by the PA application 400. ‘Find cozy place for Korean BBQ’ indicated by reference numeral 435 corresponds to an example where the user input delivered to the PA server 402 in step 410 of FIG. 4a is displayed in the form of a text.

‘Let me check the Korean˜’ indicated by reference numeral 440 represents an example of an interim response that the PA sever 402 provides to the user through the PA application 400 in step 414 of FIG. 4a. Finally, reference numeral 445 represents an example of a final response corresponding to step 420 of FIG. 4a. Specifically, two final responses for the user input requiring the place for the Korean BBQ is displayed. In addition, action sets for performing additional actions (for example, Call and Reserve actions) for the two places are displayed together.

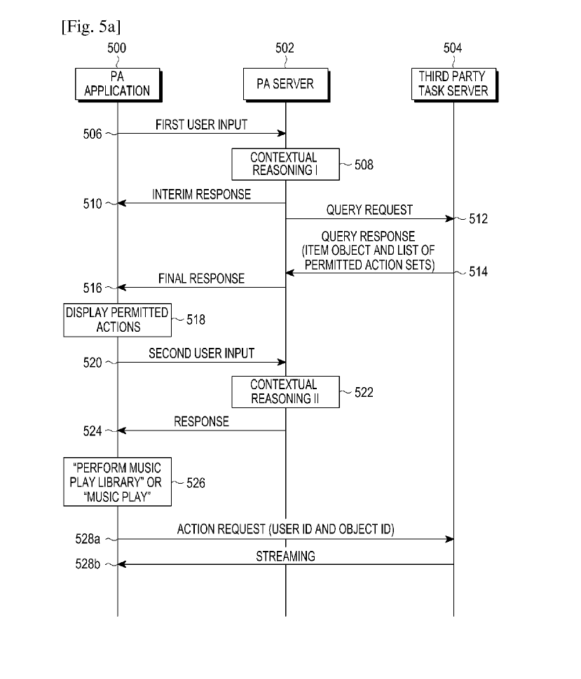

FIG. 5a is a signal flow diagram illustrating an operation of a collaborative PA system according to a second embodiment of the present invention, in which a PA server 502 provides to a user a set of additional services and actions that can be provided through a third party task server providing a task required by a user input. The PA server may perform an action by delivering a service endpoint URL of the action, at which a user device can receive an additional service other than the service through an additional action such as user's touch or click. In addition, the content object metadata that the contextual reasoned stores in advance may include natural language verbal words. The words are for identifying an action that can be performed on the content object, and the PA server may analyze and identify the action in a programming language such as play and download through natural language contextual reasoning.

Referring to FIG. 5a, in step 506, a user delivers a user input to the PA server 502 by enabling a PA application 500 in a user device. The user input is delivered in the form of natural language, or in the form of word or text. In step 508, the PA server 502 checks whether a query required by the user input requires a delegation of a third party task server. If the user input corresponds to a query requiring delegation of a third party task serer, the PA server 502 performs contextual reasoning on the user input by using pattern descriptors for the query that it stores through the procedure described with reference to FIG. 4a. Specifically, if any one of the stored natural language input patterns is matched to the user input, the PA server 502 identifies a domain of the third party task server supporting the task corresponding to the one input pattern and the web service query mapped to the input pattern. In step 510, the PA server 502 sends an interim response in the form of a message indicating, for example, that it is finding the identified domain, to the user through the PA application 500.

Thereafter, in step 512, a task delegate agent of the PA server 502 configures a query request with personal profile information (including, for example, a query command and parameters for requiring the user identifier) for the user, and sends the query request to a third party task server 504 which is matched to the query. The parameters are made from the user input together with the personal context, the dialog context and the reasoned context. The query request includes personal profile information (for example, a user identifier) of the user in order for an operator of the third party task server to identify a user or an action permission to which the user has subscribed. After receiving the query request, the third party task server 504 sends a query response corresponding to the query request to the PA server 502 in step 514. Specifically, the third party task server 504 determines whether the user has subscribed to his/her server, and whether performance of the user device is enough to support the object corresponding to the user input, if the user has subscribed to his/her server. Thereafter, the third party task server 504 includes lists of actions permitted by the user's subscription, in the query response. The third party task sever 504 may further include additional actions that can be performed by the user next after the permitted actions are performed. An example of the additional actions corresponds to an action of playing music together with a natural language text that can be presented to the user through the PA server 502. As a specific example, it will be assumed that a user has not subscribed to a third party task provider which is a music play site. In this case, the third party task provider sends to the PA server a list of actions such as ‘play for free 1 minute’ or ‘subscribe’, which can be provided to the user. If the user has subscribed to the ‘streaming play’ service but has not subscribed to the ‘download’ service, the third party task server sends only the ‘play’ action to the PA server. However, if the user has subscribed to both the ‘streaming play’ and ‘download’ services, the third party task server sends both the ‘streaming play’ and ‘download service’ actions to the PA server.

After receiving the query response from the third party task server 504 in step 514, the PA server 502 stores language keywords of the actions provided by the query response, in a personal context DB. The storage operation is for a better understanding of the user input that includes the stored keywords and will be entered later.

In step 516, the PA server 502 determines the priority of items included in the query response and supporting the task, and sends a final response comprised of the determined items to the user through the PA application 500. In step 518, the PA application 500 may display the items acquired from the final response and the actions permitted to the user for each item. In step 520, the user enters a second user input for selecting one of the displayed actions through the PA application 500. The input method corresponds to touch, click, or speaking. Upon receiving the second user input, the PA server 502 interprets the second user input as, for example, ‘music play’ using the stored personal context information in step 522. In step 524, the PA server 502 sends a response to the user through the PA application 500. The response includes content object identifier (for example, the action and URL requested by the user) corresponding to the interpreted second user input.

Thereafter, in step 526, the PA application 500 executes a music play library or a music play application in the user device, which is identified by the endpoint URL acquired from the response (for example, which can access the third party task server 504). Thereafter, for an additional action, the PA application 500 sends an action request including a user identifier and an object identifier to the third party task server 504 in step 528a. In step 528b, the third party task server 504 provides to the user a service (for example, a streaming service) corresponding to the object identifier through the PA application 500.

FIG. 5b illustrates an example of a screen of a user device, on which a service delegation operation of a collaborative PA system is displayed, according to the second embodiment of the present invention.

Referring to FIG. 5b, reference numeral 501 represents a start screen of the PA application 500. In other words, the PA application 500 displays “What can I help you with?” as an example of a query sentence for requiring a user input.

‘What is lonely?’, which is an example of a response to the query, corresponds to the first user input in step 506 of FIG. 5a. Although it is assumed herein that a response to the query is entered in sentence, a response to the query may be input to the user device in the form of speaking as described above.

Next, the description “Lonely is a music˜You can play or download the song.”, which is provided as a response to the query in FIG. 5b, corresponds to the interim response in step 510, which is acquired as a result of the contextual reasoning in step 508 of FIG. 5a.

Reference numeral 515 corresponds to the final response in step 516 of FIG. 5a. Herein, the user device provides actions (for example, play and download) permitted to the user, while providing a response to the query, for example, the music title and the playback time.

It will be assumed that a user selects ‘play’ as an example of a specific action through the second user input in step 520 of FIG. 5a. In this case, the PA server 500 displays ‘Could you play the song?’ in sentence as an example of a response to the selection of the action on the user device. The response corresponds to step 524 in FIG. 5a. The PA application 500 provides the music together with, for example, a message “O.K. I will play the song ‘lonely’” in the form of sentence, which indicates that it will play music for the user, and this corresponds to step 526 in FIG. 5a.

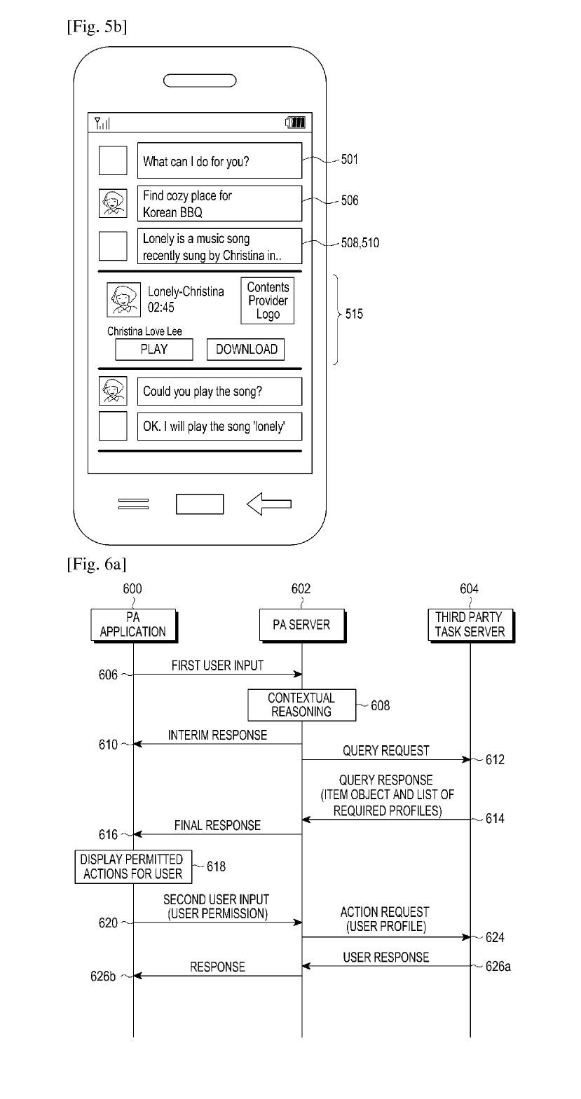

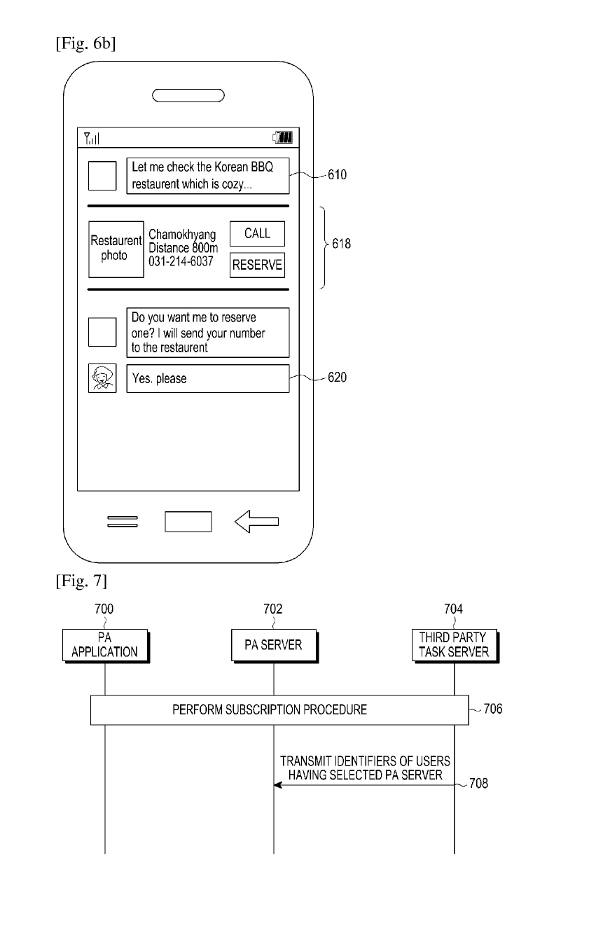

FIG. 6a is a signal flow diagram illustrating an operation of a collaborative PA system according to a third embodiment of the present invention. The collaborative PA system according to the third embodiment of the present invention provides a delegation service of registering the task corresponding to a user's request, and personal profiles required by the third party task server providing an object supporting the request, to provide the object. Specifically, while searching for the results based on the user input, the PA server acquires the user permission to share user profile information (for example, locations, phone numbers, and the like), and delivers the user profile information to the third party task server, thereby processing the action requested by the user.

Referring to FIG. 6a, in step 606, a user delivers a user input to a PA server 602 by enabling a PA application 600 in a user device. The user input is delivered in the form of natural language, or in the form of word or text. In step 608, the PA server 602 checks whether a query required by the user input requires a delegation of a third party task server.

If the user input corresponds to a query requiring delegation of a third party task serer, the PA server 602 performs contextual reasoning on the user input by using the pattern descriptors for a query, which are stored through the procedure described with reference to FIG. 4a. Specifically, if any one of the stored natural language input patterns is matched to the user input, the PA server 602 identifies a domain of a third party task server supporting the task corresponding to the one input pattern and the web service query mapped to the input pattern. In step 610, the PA server 602 sends an interim response in the form of a message indicating, for example, that it is finding the identified domain, to the user through the PA application 600.

Thereafter, in step 612, the PA server 602 configures a query request with personal information for the user, for example, a query command and parameters for requiring the user identifier, and sends the query request to a third party task server 604 that is matched to the query. The parameters are made from the user input together with the personal context, the dialog context and the reasoned context. The query request includes personal profile information (for example, a user identifier) of the user in order for an operator of the third party task server to identify a user or an action permission to which the user has subscribed. After receiving the query request, the third party task server 604 sends a query response corresponding to the query request to the PA server 602 in step 614. Specifically, the third party task server 604 has an action descriptor including personal profile information required by the query request.

The action descriptor is defined as in Table 8 below.

TABLE 8
Action descriptor

| Name | Description | Example |
|---|---|---|
| Action | Identifier (URI) of action | |
| identifier | | |
| Action | Endpoint URL for task server to | |
| endpoint | perform specified action such as | |
| URL | ‘play’, ‘download’, ‘reserve’, and | |
| | ‘buy’. | |
| Linguistic | Linguistic verb which user can say | ‘play’, |
| keyword | when user wants to perform | ‘download’, |
| | action. | ‘like’, ‘reserve’, |
| | | ‘buy’ |
| Query | Query syntax to perform specified | |
| syntax | action provided by task provider | |
| description | for end user | |
| Required | If query requires user profile or | |
| user | context information, its parameter | |
| profile | specifies list of required | |
| | parameters such as phone number, | |
| | e-mail address of user, or location | |
| | information of user, etc. | |

In step 616, the PA server 602 delivers data corresponding to the results on the query together with the user's permission request to the PA application 600 as a final response. In step 618, the PA application 600 displays content objects included in the final response on a screen of the user device, for the user.

FIG. 6b illustrates an example of a screen of a user device, on which a request for sharing user profile information of a user is displayed, according to the third embodiment of the present invention.

Referring to FIG. 6b, an interim response indicating, for example, “Let me check the Korean BBQ restaurant which is cozy you're your location” is displayed. The interim response corresponds to step 610 in FIG. 6a.

The PA server 602 displays, on the user device, a final response including searched restaurant information (for example, name, distance and phone number) and actions selectable by the user, together with the interim response. This final response corresponds to step 618 in FIG. 6a. For example, it will be assumed that the user has selected ‘Reserve’, if actions selectable by the user include Call and Reserve.

In this case, the PA server 602 allows the user to send a request for use of the user's personal information together with the user's selectable actions (for example, Call and Reserve).

In step 620, it will be assumed that the user delivers ‘Permission’ for the request to the PA server 602 by entering it as a second user input through the PA application 600. The PA server 602 sends a response to the reception of the second user input through the PA application 600. In step 624, the PA server 602 sends an action request including the action requested by the user and personal profile information (for example, phone number or location information) required for the action, to the third party task server 604. Since the user has selected ‘Reserve’ as an action as described above, the required personal profile information may include user's phone number or location information. In steps 626a and 626b, the third party task server 604 sends a user response corresponding to the action to the PA application 600 through the PA server 602.

FIG. 7 is a signal flow diagram illustrating a pre-processing procedure for user identification between a PA server and a third party task server according to an embodiment of the present invention. In order for the PA server to recognize the user's permission for the task and content object required by the user, a pre-processing procedure for associating the user information managed by each of the PA server and the third party task server needs to be involved. The general third party task server manages identifiers of the users who have subscribed thereto. The pre-processing operation is required in the second and third embodiments of the present invention.

The pre-processing operation is performed while an arbitrary user subscribes to an arbitrary third party task server. For example, if the third party task server shows the user a list of PA servers during the subscription procedure, the user selects one PA server from the list. The third party task server requests identification of the PA server from the user. In this manner, during the subscription procedure, the third party task server may acquire an identifier of a PA server associated to the user.

Referring to FIG. 7, in step 706, a user performs a subscription procedure to a third party task server 704 through a PA application 700 operating in a user device. Although one third party task server 704 is considered by way of example, a pre-processing procedure for user identification needs to be involved for each of the third party task servers providing the service that the PA server 702 desires to delegate.

If the subscription procedure is completed, the third party task server 704 delivers user information of the users, who have subscribed to the third party task server 704, to the PA server 702 in step 708. For example, the user information managed by the third party task server 704 is represented as in Table 9 below.

TABLE 9
User information and list of permitted
actions in third party task server

| Name | Description | Example |
|---|---|---|
| User | User identifier and security | User id and password |
| credential | information for verifying | |
| | user for task service | |
| | provider | |
| Associated | Personal assistant server's | This information can |
| user | user identifier | be acquired from user |
| identifier | | during subscription |
| List of | Action which user can take | For music service, |
| permission | on objects based on user | permitted actions can |
| actions | subscription information. | be one of followings: |
| | For example, content object | “play for free 1 |
| | is music song, and permitted | minute”, “play”, and |
| | actions can be one or both | “download” |
| | of ‘play’, ‘download’. | |

The user information manage by the PA server 702 may be represented as in, for example, Table 10 below.

TABLE 10
User information on personal assistant server

| Name | Description | Example |
|---|---|---|
| User | User identifier and security information | User id and |
| credential | for verifying user for personal assistant | password |
| | server | |
| Associated | Subscribed third party task server | |
| third party | identifier, and its user identifier for | |
| task server | the same user | |
| information | | |

As is apparent from the foregoing description, the above-described collaborative PA system delegates a service operation of the third party task server providing the task and object corresponding to a user input, thereby reducing the unnecessary procedures and resolving the existing problems, compared to the operation in which the user directly access the third party task server and obtains the task and object.

sonal profile information while providing the task to the user.

While the invention has been shown and described with reference to certain exemplary embodiments thereof, it will be understood by those skilled in the art that various changes in form and details may be made therein without departing from the spirit and scope of the invention as defined by the appended claims and their equivalents.

1. A collaborative Personal Assistant (PA) system for delegating provision of services by third party task providers, the system comprising:
a contextual unit configured to search for a first third-party task provider supporting a first task required by a user input by using natural language input patterns for tasks supported by services operated by the third-party task providers; and
a server of a task delegate unit configured to provide to the user a service and an action required by the user input for the first task and configured to provide additional service and actions supporting the first task to the user regardless of the user input.

2. The collaborative PA system of claim 1, wherein the contextual unit is configured to check whether the user input is matched to any one of the natural language input patterns, and if the user input is matched to any one of the natural language input patterns, the task delegate unit is configured to perform a delegation operation of the first third-party task provider supporting the first task corresponding to a web service query mapped to the input pattern.

3. The collaborative PA system of claim 2, wherein the natural language input patterns are mapped to a web service query for a delegation operation of tasks supported by services operated by the third-party task providers.

4. The collaborative PA system of claim 1, wherein the task delegate unit is configured to display a service and an action required by the user input on a screen of a user device for the first task, and is additionally configured to display on the screen, input methods with which the user may select the additional service and actions.

5. The collaborative PA system of claim 4, wherein the input method includes receiving a touch input, receiving a button click from a button displayed on a screen of the user device, or receiving an audible input on the user device.

6. The collaborative PA system of claim 1, wherein the task delegate unit is configured to send an accept request for use of personal information to the user if the additional service and actions supporting the first task require personal information of the user, and upon receiving an acceptance for use of the personal information from the user, the task delegate unit is configured to provide the additional service and actions supporting the first task to the user by delivering the personal information to the first third-party task provider.

7. A method for delegating provision of services by third-party task providers in a collaborative Personal Assistant (PA) system, the method comprising:
searching for a first third-party task provider supporting a first task required by a user input by using natural language input patterns for tasks supported by services operated by the third party third-party task providers;
providing to the user a service and an action required by the user input for the first task; and
providing an additional service and actions supporting the first task to the user regardless of the user input.

8. The method of claim 7, wherein searching for the first third-party task provider comprises:
checking whether the user input is matched to any one of the natural language input patterns; and
if the user input is matched to any one of the natural language input patterns, performing a delegation operation of the first third-party task provider supporting the first task corresponding to a web service query mapped to the input pattern.

9. The method of claim 7, wherein the natural language input patterns are mapped to a web service query for a delegation operation of tasks supported by services operated by the third-party task providers.

10. The method of claim 9, wherein performing the delegation operation comprises:
displaying a service and an action required by the user input on a screen of a user device, for the first task; and
additionally displaying, on the screen, input methods with which the user may select the additional service and actions.

11. The method of claim 10, wherein the input methods include receiving a touch input, receiving a button click from a button displayed on a screen of the user device, or receiving an audible input on the user device.

12. The method of claim 7, further comprising:
sending an accept request for use of personal information to the user if the additional service and actions supporting the first task require personal information of the user; and
upon receiving an acceptance for use of the personal information from the user, providing the additional service and actions supporting the first task to the user by delivering the personal information to the first third-party task provider.
